(19) United States
(12) Patent Application Publication
(10) Pub. No.: US 2007/0095875 A1
(43) Pub. Date: May 3, 2007

(54) Single-blow pneumatic nailing tool

(75) Inventor: Frederick W. Lamb, McCalla, AL (US)

Correspondence Address: Russell H. Walker;Walker, McKenzie & Walker, P.C., Suite 434, 6363 Poplar Avenue, Memphis, TN, 38119-4896, US

(73) Assignee: PneuTools, Incorporated, Memphis, TN (US)

(21) Appl. No.: 11/592,496

(22) Filed: Nov. 3, 2006

Related U.S. Application Data
(60) Provisional application No. 60/733,078, filed on Nov. 3, 2005.

(51) Int. Cl. B25C 1/04

(52) U.S. Cl. 227/8; 227/130

(57) ABSTRACT

A compact single-blow pneumatic nailing tool for installing metal joist hangers and metal plates in wood-constructed houses. A lower nosepiece reciprocates with respect to an upper nosepiece, and, as the lower nosepiece reciprocates, an attached nail magazine moves jointly therewith. A safety linkage connected to the magazine engages a trigger lever and permits the tool to be fired only when the lower nosepiece is pressed against the workpiece. The tool does not need a guide tip or elaborate safety to guide a nail into a hole in the workpiece, and does not have a vision-blocking safety mechanism on the tip of the nose. The tip of the nail sticks out of the nose of the tool, facilitating placement into a hole in the workpiece.

### CROSS REFERENCE TO RELATED APPLICATIONS

This application claims priority of pending U.S. Provisional Patent Application 60/733,078, filed Nov. 3, 2005, entitled Single-Blow Pneumatic Nailing Tool, fully included by reference herein.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to pneumatic tools that install metal straps and metal joist hangers as are used to tie the wood construction together and make a stronger house, and in particular, to single-blow nailing tools.

2. Information Disclosure Statement

It is often desired to have a compact nailing tool that will fit between the rafters in a house under construction, in which the tool is of a “single-blow” type such that the nail is driven into the work surface in one hit of the driver blade. It is also desired to have a single-blow tool that does not need to use hardened nails and does not need to have a hardened guide tip to locate the hole in the steel. More than anything, it is greatly desired to have a single-blow tool that is safer than prior art tools yet does not have or require a safety mechanism anywhere on the nose of the tool, because such a safety mechanism, if present, obscures the user's view of the workpiece being nailed.

Hurricane areas, earthquake areas and tornado areas, including all of the costal areas, use a greater amount of metal straps and hangers. In these high-volume nailing areas it is important to be able to install the large volume of nails required for the job as quickly as possible. There are a number of prior art tools on the market used for such purposes. Tool manufacturers Paslode, Hitachi and Bostitch all use large framing nail guns to do this job.

There are a number of major problems with such prior art tools. The first problem is that the tools are very large and tall and they will not fit into small places, like between the rafters where metal rafter tie-downs are often installed. Another problem with two of these tools is that they need to have a hardened guide tip to guide the nail into the hole in the steel plate workpiece. In other words, the hardened guide tip of prior art tools acts as an elaborate safety mechanism, which, in turn, causes several additional problems. Because they need a guide tip to help the nail to locate the hole, they must use a hardened steel nail, which is very expensive. If they did not use a hardened steel nail, the chance of the nails missing the hole and bouncing off of the steel plate workpiece would be very great, which creates a very dangerous condition. Another problem is that such a hardened guide tip often breaks, causing down time and the cost to replace the broken tip, which is also expensive. And the last big problem with these tools is they have this hardened guide tip, which acts as an elaborate safety, that hangs down and gets in the way of the operators line-of-sight. There is a unique compact palm nailer, with a magazine that has the tip of the nail hanging out the nose of the tool, thereby enabling the nail to be placed directly into the hole of the steel plate workpiece. Such a small palm nailing tool is ideal for confined nailing situations but is not fast enough for the high-volume nailing requirements of certain areas of the country. The reason it is not fast enough is because a palm nailer is a multi-blow tool, such that the driver blade in the tool hits the head of the nail many times before the nail is driven all of the way into the workpiece.

It is therefore desirable to have small single-blow tool that will fit into very small places, mainly between one foot floor joist and one foot rafters. It is also desirable to have a single-blow tool that does not use hardened nails or a hardened nail guide tip (elaborate safety), and which is safer than tools heretofore known.

Another desired feature is to have a tool that does not have a safety mechanism hanging down in the line-of-sight between the user and the workpiece.

### BRIEF SUMMARY OF THE INVENTION

The present invention is a lightweight single-blow tool that is around 10″ tall or less, enabling it to be used in very small areas. The present invention, because of its novel design, has no safety on the nose of the tool and does not need a hardened nail guide tip for guiding the nail into the hole. The design of the present invention also enables the user to place the tip of the nail directly into the hole of the metal workpiece, making this one of the safest tools on the market. It also does not need a hardened guide tip or elaborate safety to guide the nail into the hole in the steel. This invention does not have a safety on the tip of the nose. It is however, a very safe tool. The tip of the nail also sticks out of the nose of the tool making it very easy for the operator to place it into the hole in the steel. The present invention has an upper nosepiece and a spring-loaded lower nosepiece, and the lower nosepiece reciprocatingly slides upward into the upper nosepiece, thereby creating a telescoping nose, with a biasing spring urging the lower nosepiece to be telescopingly extended from the upper nosepiece. A magazine full of nails is mounted to the lower nosepiece for mutual movement therewith, and a safety linkage mounted to the magazine, thereby having mutual movement with the lower nosepiece, is operably connected to an actuating trigger. When the lower nosepiece is reciprocated into the upper nosepiece as the tool is pressed onto the workpiece, the safety linkage allows the trigger to actuate a trigger valve that causes the nail to be driven into the workpiece. If the lower nosepiece is not reciprocated into the upper nosepiece, as happens when the tool is not pressed into the workpiece, the safety linkage prevents the trigger from actuating the nail-driving mechanism, creating a safe condition because nails cannot be fired due to the safety linkage's prevention of nail driving actuation. Because of this feature, the present invention does not need a safety device on the nose of the tool. This is a great benefit because the user is able to see the tip of the nose of the tool and is thus able to accurately place the tip of the nail into the hole of the metal workpiece, which results in a tool that is safer than heretofore known in the prior art. When the tool is pushed downward, the safety linkage that is mounted to the nail magazine is caused to travel upward at the same time, thereby lifting the trigger linkage and enabling the operator to pull the trigger and fire a nail. Because of these features, the present invention is light weight, small, easy to use, and solves all of the current problems associated with the other tools on the market.

### BRIEF DESCRIPTION OF THE SEVERAL VIEWS OF THE DRAWING

FIG. 1 is a right side view of the present invention showing the tool in the not-ready-to-fire position in which the lower nosepiece is telescoped out from the upper nosepiece.

FIG. 2 is a right side view of the present invention similar to FIG. 1, but showing the tool in the ready-to-fire position in which the lower nosepiece is pressed against the workpiece and thus moved upwardly into the upper nosepiece.

FIG. 3 is a left side view of the present invention showing the tool in the not-ready-to-fire position, with a portion of the tool body cut away to schematically show the movement of the driving piston.

FIG. 4 is a schematic view of significant parts of the present invention shown in the not-ready-to-fire position in which the lower nosepiece is telescoped out from the upper nosepiece, and showing how the safety linkage prohibits the trigger from actuating the trigger valve.

FIG. 5 is a schematic view of significant parts of the present invention shown in the ready-to-fire position in which the lower nosepiece is pressed against the workpiece and thus moved upwardly into the upper nosepiece, and showing how the safety linkage permits the trigger to actuate the trigger valve.

### DETAILED DESCRIPTION OF THE INVENTION

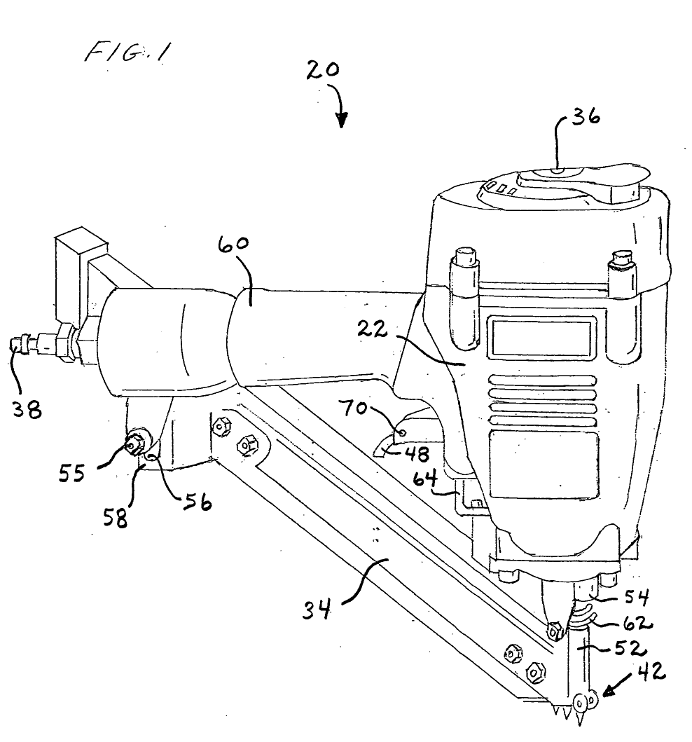

Referring to FIGS. 1 through 5 of the drawings, the structure of the present invention is shown. Some parts of the present invention are similar in structure to the prior art, and those parts will first be described, followed by a description of the improvements that are novel to the present invention.

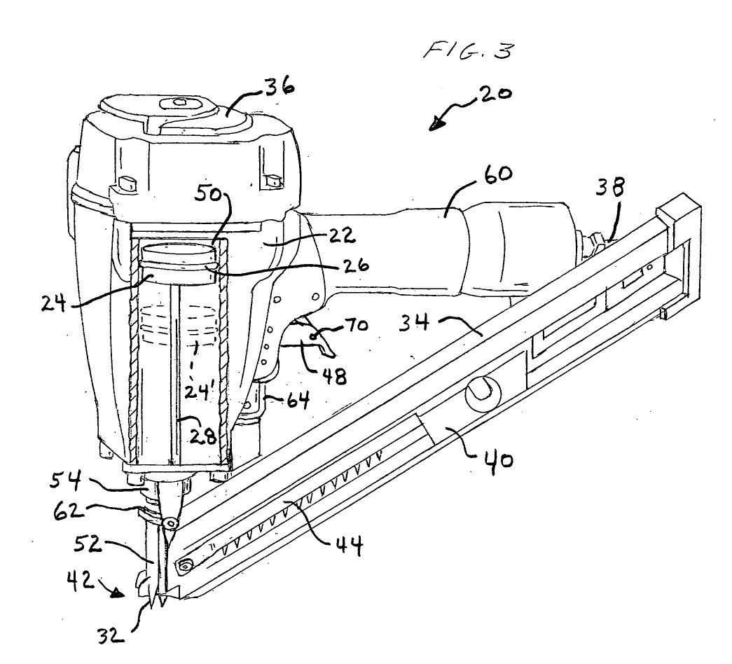

Pneumatic nailing tool 20, like other prior art pneumatic nailing tools, has a body 22 which houses a vertically-reciprocating piston 24 having a circumferential O-ring 26. An axially-disposed nail-driving shaft 28 extends downwardly from piston 24 to engage the head 30 of the leading nail 32 in the nail magazine 34, and piston 24 is caused to move rapidly downward when a poppet valve (not shown) in the head 36 of tool body 22 causes compressed air to flow from a well-known air supply provided at nipple 38. A well-known spring-loaded pusher 40 is mounted for longitudinal reciprocation within magazine 34, and pusher 40 is pulled toward the tip 42 of tool 20 by a pusher spring 44, thereby causing a sequence of nails within magazine 34 to be supplied to tip 42 for driving into a workpiece W. A trigger valve 46 is provided that, when actuated by trigger 48, causes the poppet valve to release air from the air supply into the piston chamber 50, thereby causing piston 24 to move rapidly downward, as shown in dotted outline as 24′ in FIG. 3, and drive the leading nail 32 into the workpiece W. This much is well-known in the prior art.

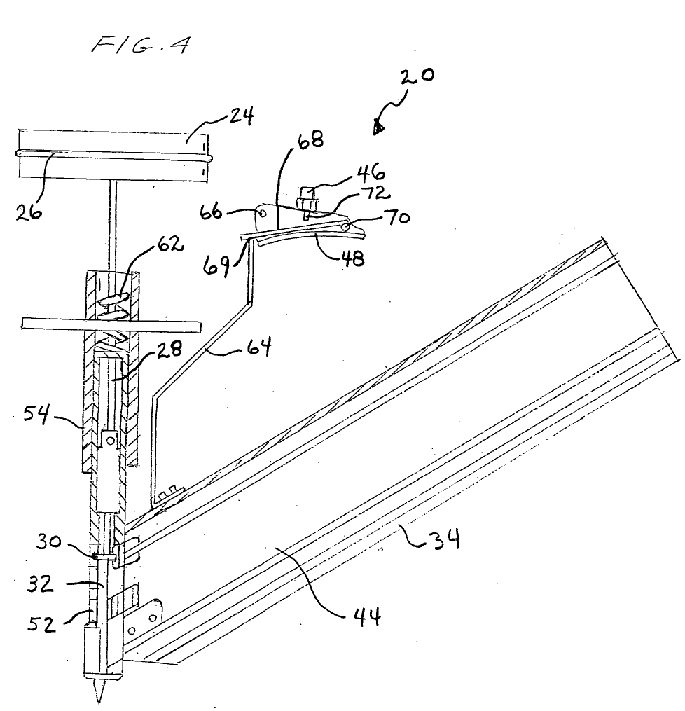

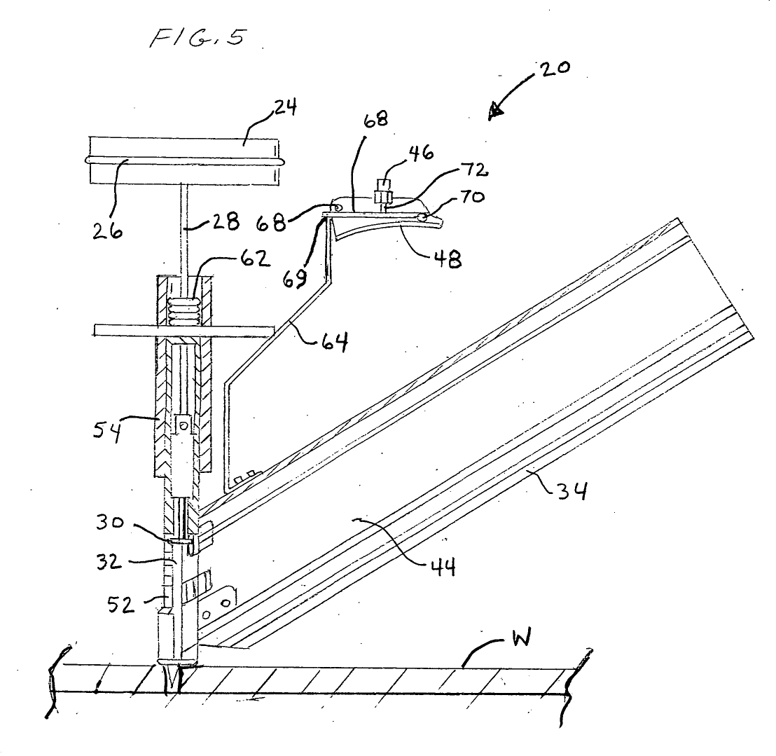

The improvement of the present invention can now be described in detail. A lower nosepiece 52 is mounted for telescoping reciprocation within an upper nosepiece 54, and magazine 34 is fixedly mounted to lower nosepiece 52 for joint movement therewith. The rear of magazine 34 is slidingly mounted, as by a bolt 55 on the rear of tool handle 60, within an oblong slot 56 of a bracket 58 mounted to magazine 34 such that the rear of magazine 34 is allowed to reciprocate up and down with respect to handle 60 as bolt 55 moves within slot 56 as magazine 34 jointly moves up and down with lower nosepiece 52. A coiled compression spring 62 engages lower nosepiece 52 and biases lower nosepiece 52 to be telescoped outwardly, and thus downwardly, from within upper nosepiece 54. It should be understood that coiled compression spring 62 may be placed inside upper nosepiece 54 and in contact with the top of lower nosepiece 52, as shown in FIGS. 4 and 5, or alternately and equivalently may be placed below upper nosepiece 54 and in contact with a flange on lower nosepiece 52, as shown in FIGS. 1-3; the essential function performed by spring 62 is to bias lower nosepiece 52 to telescope outwardly and downwardly from upper nosepiece 54 so that, when the tool is lifted from the workpiece W, lower nosepiece 52 will telescope out and away from upper nosepiece 54. Axially-disposed nail-driving shaft 28 passes axially through upper nosepiece 54 and lower nosepiece 52 and contacts the head 30 of the leading nail 32. Upper nosepiece 54 is fixedly mounted to body 22 of tool 20, so that lower nosepiece 52 reciprocates with respect to body 22 as the lower nosepiece is pressed against the workpiece W for nailing.

Mounted to magazine 34, and thus moving jointly with lower nosepiece 52, is a safety linkage 64 that is operably connected to actuating trigger 48 in a manner that will now be described in detail. Trigger 48 is mounted for angular movement with respect to body 22 about a first pivot 66 that is attached to body 22, from an un-actuated position to an actuated position. A trigger lever 68 is provided within trigger 48, and trigger lever 68 is, in turn, mounted for angular movement with respect to trigger 48 about a second pivot 70 that is attached to trigger 48. Referring to FIGS. 4 and 5, which show safety linkage 64 in a somewhat-exaggerated schematic depiction for the purposes of explanation of the operative structure of the present invention, it can be seen that when lower nosepiece 52 is not pressed against the workpiece, as shown in FIG. 4, when the tool is in the “not-ready-to-fire” position, safety linkage 64 does not engagingly urge a distal portion 69 of lever 68, remote from second pivot 70 of trigger lever 68, upwardly, thereby preventing trigger lever 68 from engaging the pin 72 of trigger valve 46 as trigger 48 pivots about first pivot 66 from the un-actuated position to the actuated position. However, when lower nosepiece 52 is pressed against the workpiece W, as shown in FIG. 5, when the tool is in the “ready-to-fire” position, safety linkage 64, because of the upward reciprocation of lower nosepiece 52 and magazine 34 with respect to body 22, engages the distal portion 69 of trigger lever 68 and urges the distal portion 69 of trigger lever 68 upwardly so that, as trigger 48 pivots about first pivot 66, trigger lever 68 engages and actuates the pin 72 of trigger valve 46 intermediate distal portion 69 and second pivot 70. Thus it is seen that, when the lower nosepiece 52 is depressed against the workpiece W so that the tool is in the “ready to fire” position, then and only then trigger 48 is permitted to actuate trigger valve 46, which, in turn, actuates the poppet valve in the head 36 of tool body 22, thereby causing piston 24 to move rapidly downward and drive the leading nail 32 into the workpiece W. A safety mechanism is thus provided in accordance with the present invention that prevents firing of the nail unless the lower nosepiece is pressed firmly against the workpiece W, and, in contrast to the prior art, the safety mechanism of the present invention does not block the operator's view of the nail entering the workpiece W.

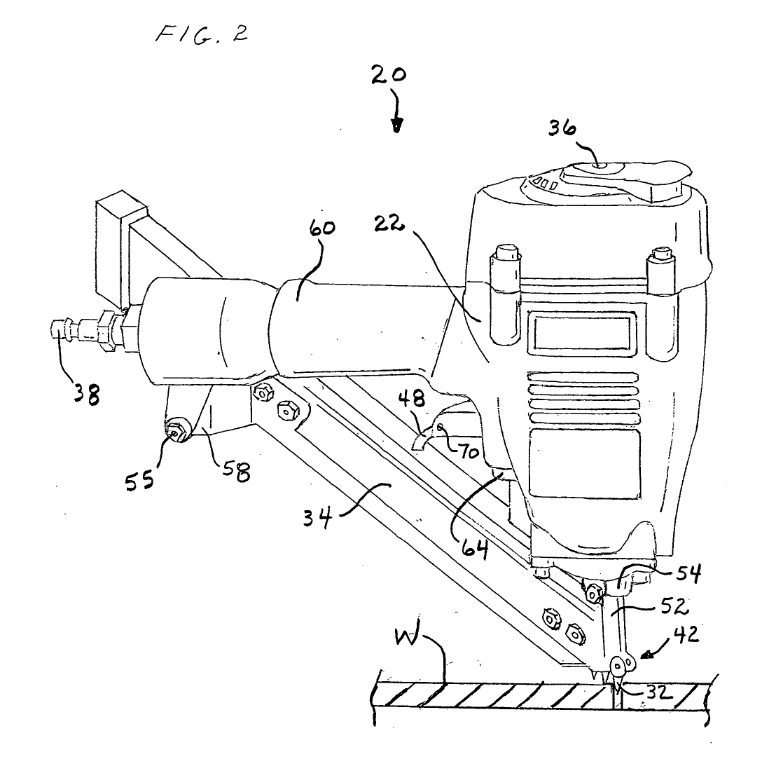

The usage and firing of the tool will again be explained now that the details of the structure of the invention have been explained. The tool 22 is hooked to a well-known air source such as an air compressor by attaching an air hose between the air source and nipple 38. Referring to FIGS. I and 4, showing the tool not ready to be fired, the tip of the nail 32 can be seen, and this tip is placed into a hole in the steel strap workpiece W. Trigger lever 68 is in the down position, as is the safety linkage 64. When these parts 64, 68 are in this position, the tool will not fire even it the trigger 48 is pulled upward. Referring to FIGS. 2 and 5, showing the tool in the position ready to be fired, both the safety linkage 64 and the trigger lever 68 are in the up position. When they are in this position, the trigger 48 can be pulled up to the actuated position and the tool will then fire. The following is a description of how the tool is fired. First, as already mentioned, the tip of the leading nail 32 is placed into the hole of the steel plate workpiece W. The operator then pushes down on the handle of the pneumatic tool. When the handle of the tool is pushed down, the upper nosepiece 54 begins to travel downward with respect to the lower nosepiece 52, the safety linkage 64 begins to travel upward at the same time the spring 62 is compressed. Handle 60 also travels to the bottom of its stroke at the same time as bolt 55 slides within oblong slot 56 of bracket 58. As this is all happening, the safety linkage 64 travels to the top of its stroke and causes the trigger lever 68 to be raised, thereby enabling pin 72 of trigger valve 46 to be actuated as trigger 48 is pulled to the actuated position, the tool is fired, and a nail is driven into the workpiece W.

FIGS. 1 and 4 show the trigger 48 and the trigger lever 68 in the position where, if the trigger is pulled upward toward the pneumatic tool to the actuated position, the tool would not fire.

The unique quality of this tool is there is no need of a cumbersome safety mechanism on the nose of the tool although the tool operates just as if one were present. No vision-obstructing safety mechanism is required on the nose of the tool, in contrast to the prior art.

As heretofore described, the tool has a lower nosepiece 52, which is attached to the magazine 34, and the lower nosepiece 52 travels up and down allowing the tool to be fired. This is unique to a single-blow tool.

The tool 20 preferably has the safety linkage bolted to the top of the magazine and operates in conjunction with the lower nosepiece and magazine.

Another very important quality is this tool does not need to have a hardened nail. This is because the tip of the nail is placed directly into the hole of the steel workpiece, which makes for a very safe tool. Because there is no safety mechanism hanging down on the front of the nose of this tool, in contrast to the prior art, the operator is able to see exactly where the tip of the nail is being placed.

Significant features of the present invention are thus understood to be:
1) No safety linkage on the nose of the tool.
2) The tool has a lower nosepiece and an upper nosepiece. The lower nosepiece is connected to the magazine and the magazine and lower nosepiece move up and down together.
3) The safety linkage that the tool does have is attached to the top of the magazine and travels up and down when the lower nosepiece and magazine travel up and down.

Although the present invention has been described and illustrated with respect to a preferred embodiment and a preferred use therefor, it is not to be so limited since modifications and changes can be made therein which are within the full intended scope of the invention.

I claim:

1. A single-blow pneumatic nailing tool having a pneumatic piston for driving a nail into a workpiece, said tool comprising:
(a) a tool body, said tool body having an upper nosepiece;
(b) a lower nosepiece mounted for telescoping reciprocation with respect to said upper nosepiece between a not-ready-to-fire position, in which said lower nosepiece is extended from said upper nosepiece, and a ready-to-fire position;
(c) spring means for urging said lower nosepiece into said not-read-to-fire position;
(d) a valve for selectively supplying a source of air to drive said piston;
(e) a trigger mounted for angular movement with respect to said tool body about a first pivot, from an un-actuated position to an actuated position;
(f) a lever mounted to said trigger for angular movement with respect to said trigger about a second pivot remote from said first pivot, said valve being mounted for actuation by said lever, said lever having a distal portion remote from said second pivot;
(g) a linkage operably coupling said lower nosepiece to said distal portion of said lever, such that, when said when said nosepiece is in said not-ready-to-fire position, said lever does not actuate said valve, and when said nosepiece is in said ready-to-fire position, said lever actuates said valve.

2. The tool as recited in claim 1, in which said lever engagingly actuates said valve intermediate said distal portion and said second pivot.
